(19) United States
(12) Patent Application Publication
(10) Pub. No.: US 2011/0144775 A1
(43) Pub. Date: Jun. 16, 2011

(54) Method and apparatus for adapting a process instance

(76) Inventors: Peter Killisperger, Wertingen (DE); Markus Stumptner, North Adelaide (AU); Thomas Stückl, Munich (DE)

(21) Appl. No.: 12/654,094

(22) Filed: Dec. 10, 2009

(51) Int. Cl. G06F 19/00; G05B 13/02

(52) U.S. Cl. 700/30

(57) ABSTRACT

A method and an apparatus are disclosed for adapting a process instance, which guarantee that process instances are conform to a specific process meta model. Therefore constraint violations are detected and furthermore remedied according to a derived violation meta model. In at least one embodiment, the present invention finds application in process modeling, system process optimization and/or controlling of machines or technical devices.

### FIELD

At least one embodiment of the present application generally relates to a method and/or an apparatus, which allow a correct and fault robust execution of manufacturing processes and machine control processes, and more especially relates to a method and/or an apparatus for adapting a process instance. At least one embodiment of the present application furthermore generally relates to a computer program being adapted to perform the method on a computer as well as a data carrier, which stores the computer program.

### BACKGROUND

Manufacturing plants as well as assembly lines comprise several machines, which have to be coordinated as regards their cooperation for reaching a predefined goal. It may for instance be the case that a product passes along an assembly line with several machines performing individual production steps for assembling the product. In several application domains the assembling procedure is bound to specific assembling plans and high quality standards. It may therefore be necessary that the assembling machines operate exactly according to a detailed production plan. Typically not only one single machine is operated, but a variety of several machines, which interact and work on common artifacts. It may therefore be necessary that communication among the machines and several further resources has to be established. It may be the goal to define and execute assembling and/or working procedures, which can be performed in an automated fashion.

Because of the size and complexity the procedures are usually defined in a generic fashion as reference processes so that they can be reused across a variety of projects in one or more companies. In order to apply them to a specific project the procedures have to be adapted, which may be time consuming and error prone due to the complexity and size of the processes. While detail is usually hidden by using different abstraction levels it may still be the case that processes incorporate a huge variety of steps.

The task of adapting a reference process for a project is complicated by modeling restrictions originated from modeling guidelines. Such a guideline may be formulated as: “a document must be created by an activity before it can be used by another activity” or “a control flow cannot connect an And-split with an And-join node”. The company's reference process may specify requirements that certain mile stones have to be passed or quality goals have to be achieved. The rules ensure that processes follow certain correctness specifications within an organization which were developed to minimize errors and to support the understanding of processes.

AndSplit represents a point in the process where a single thread of sequence flow (i.e. instance of ControlFlow) splits into two or more threads (i.e. instances of ControlFlow), which are executed in parallel within the process, allowing multiple activities to be executed simultaneously. AndJoin represents a point in the process where multiple parallel sub processes converge into one single thread of control (i.e. instance of ControlFlow), thus synchronizing multiple threads (i.e. instances of ControlFlow)

So far, the instantiation of reference processes in software development is a manual task on two levels. First, the decisions on how a reference process is adapted are made based on the expertise of the project manager and second, the adaptation is executed manually by a human process modeler.

For example, one may consider a reference process that includes a task, which does not need to be executed in a particular project because its activity is subsumed by another task performed at a different point in the process. There are no specific rules from which it could be derived automatically if the task needs to be performed or not. A process modeler usually removes the task manually from the process. This may be an error-prone, time consuming and expensive step because removing a task may have malicious effects on the process which are not obvious to see. For example, the removed task produces a document that is required by another task later in the process flow.

Existing tools provide only minimal support for project specific adaptation. One reason for that is the complexity involved in the adaptation of processes which is caused by the size and the hierarchical organization of reference processes as well as the required flexibility during the instantiation process. Processes often contain several thousand elements and are nested on several abstraction levels. Flexibility is necessary because the instantiation is usually not performed in a single step but in several steps while the project is already progressing.

However, automated support such as solving inconsistencies is often not provided. There are known approaches for self healing processes for automatic execution by engines. Processes in this area are defined in a process template, i.e. reference process, and then executed many times with only little adaptations and are executed in short time frames. The focus of these approaches is on guaranteeing correct automated execution of processes by ensuring properties like absence of deadlocks, proper process termination and reachability. They solve issues arising due to this nature e.g. assignment of application components such as web services to activities or propagation of change made in the process template to currently executed instances. In order to enable this support, complexity of process is limited.

One of the most popular process modeling language denotes the Event-driven Process Chain (EPC) modeling language. It has gained a broad acceptance and popularity both in research and in practice. An EPC Model is a directed and connected graph whose nodes are events, functions and logical connectors which are connected by control flow arcs. Functions represent the time consuming elements by performing tasks on process objects. Each function has exactly one ingoing and one outgoing arc. Further, a function transforms a process object from an initial state into a resulting state captured by events that represent the passive elements. The state information is also bound to a text phrase. Each event has at most one ingoing and at most one outgoing arc. A connector can be either an AND-, an OR-, or an XOR-connector. A connector has multiple ingoing arcs and one outgoing arc (join), or it has one ingoing arc and multiple outgoing arcs (a split).

Semi-formal modeling languages provide little restrictions on how to model a process. For example, they do not restrict types of resources which can be assigned to execute an activity. This allows the modeler to assign for example a system to a manual activity for executing it which is obviously not correct. Meta models may be used to restrict this freedom in order to meet requirements of system and product development. Meta models restrict process modeling languages by defining permitted elements and constructs in a process.

Restrictions can be distinguished between syntactic and semantic restrictions. The former restrict process elements on the basis of their type for example entity type work products have to be created by an activity before they can be consumed by an activity. Semantic constraints restrict instances of an entity type, for example instance “Develop Design” of activity has to be executed before instance “Implement Design” of activity.

Due to the high degree of freedom in semi-formal modeling languages many syntactical restrictions are necessary in order to constrain the languages in order to meet requirements of system and product development. Definition and check of semantic restrictions is even more expensive, since they restrict instances which are usually in numbers much bigger than types of elements.

Because of their size and complexity, processes are not defined for projects individually but in a generic way as reference processes for application in any system and product development project. Due to the individuality of system and product development, reference processes have to be instantiated to be applicable in projects.

This means that the generic description of the process is specialized and adapted to the needs of a particular project. One can define instantiation to comprise tailoring, resource allocation and the instantiation of artifacts. During its application in a project, a process has to be adapted and/or instantiated step by step to meet project specific requirements due to the dynamics of product development. They do not allow instantiation of the complete process at the start of the project. This results in a number of variations of a process used for a particular project. After each process adaptation the resulting process has to comply with the restrictions of the meta model. From this follows that a process has not only to be checked for adherence of restrictions and possibly corrected when the process is created. A process has to be checked and possibly corrected many times during the course of every project the process is applied in since processes have to be instantiated to project specific needs.

Commonly known methods do not provide device for efficient and reliable process adaptation or instantiation. Frequently occurring changes as regards sequences of assembling and/or manufacturing activities are error prone and subject to considerable labor. Applying the known methods it may occur, that a product of an assembly line violates quality standards and/or that machines do not operate according to a predefined procedure specification.

### SUMMARY

At least one embodiment of the present invention provides a method and/or an apparatus for ensuring that predefined procedure models are consistent and that the certain constraints as regards the operation of the machines are not violated. Especially, at least one embodiment of the present invention provides a method and/or an apparatus for adapting a process instance.

At least one embodiment of the invention provides a method for adapting a process instance, the process instance violating at least one constraint is provided, the method comprising:
deriving a violation meta model from a stored process meta model;
identifying a constraint violation in the process instance, the process instance being provided as a function of the stored meta model; and
adapting the identified constraint violation based on the derived violation meta model.

A process instance may define a sequence of steps, which are to be accomplished by a machine and/or a technical device. The process instance may comprise a variety of activities, events and further entities, which are related according to a temporal or a causal relation. A temporal relation may for instance define that the specific activity is accomplished before another activity. Once an activity is accomplished an event may occur. For generating a process instance a process meta model may be required. A meta model may define that a process has several entities and constraints.

A constraint is a predefined rule, which has to be fulfilled by the process instance. The temporal relation can be formulated as one constraint as regards two activities. In case the order of the activities as being modeled by the process instance contradicts with at least one predefined constraint the process instance violates the constraint.

For formulating the constraints a violation meta model can be provided. It may also be the case that the violation meta model is derived from a stored meta model. The stored process meta model may define that a control flow is always modeled between two entities. In case a process instance does not comprise two entities each connected by a control flow the violation meta model may define a process instance adaption technique, which remedies the violation. The violation meta model can define that in case a control flow is assigned to only one entity, then the control flow is deleted. The violation meta model may suggest a certain process instance adaption technique and/or may model several process instance adaption patterns, which can potentially be applied as regards the violation. Furthermore, a specific process instance adaption technique cost can be modeled in the violation meta model. A cost of a process instance adaption technique specifies a complexity of applied functions for healing a constraint violation. A cause can for instance be a number of subsequent steps, which have to be performed in order to remedy the violation of the constraint and/or a number of lookups in a database. The person skilled in the art appreciates further ways for deriving a violation meta model and especially for assigning costs to parts of the violation meta model.

Furthermore, identifying a constraint violation in the process instance is performed. A violation of a constraint can be identified by a comparison of a violation meta model, an instance of the violation meta model, the process instance and/or the process meta model. Identifying a constraint violation may comprise further substeps, such as a creation of a violation meta model instance, which describes a process instance adaption techniques. Furthermore constraints, which are violated can be detected by techniques, such as pattern matching or further techniques related to process engineering.

As constraint violations in the process instance are identified and process instance adaption techniques are provided according to the violation meta model, the identified constraint violations can be adapted. Adapting the identified constraint violation and/or the identified constraint violations may comprise adapting the process instance in a way that it is conform to the stored process meta model. This step may comprise reading out a process instance adaption technique from the violation meta model and/or a instance of the violation meta model, for identifying how a specific constraint violation is to be treated such that the constraint violation is remedied and furthermore that the process instance is conform to the stored process meta model. This can be accomplished by performing at least one of a group of functions, the group comprising deleting, inserting, changing, renaming, remodeling, selecting and further process instance correction techniques.

In an embodiment of the method according to an aspect of the present invention the derived violation meta model comprises at least one process instance adaption technique.

This has the advantage that the constraint violation can be remedied automatically based on the derived violation meta model and/or an instance of the derived meta model.

In yet a further embodiment of the method according to an aspect of the present invention the step of identifying the constraint violation is performed as a function of the derived violation meta model.

This has the advantage that the violation meta model describes certain patterns as regards the process instance, which have to be adapted.

In yet a further embodiment of the method according to an aspect of the present invention the derived violation meta model describes at least one constraint violation.

This has the advantage that one or several constraint violations can be predefined in a violation meta model and/or in a derived violation meta model.

In yet a further embodiment of the method according to an aspect of the present invention at least one process instance adaption technique is assigned to each constraint violation.

This has the advantage that each constraint violation can be remedied by one or several adaption techniques. Therefore constraint violations and adaption techniques can be modeled in separate models, which can be interlinked.

In yet a further embodiment of the method according to an aspect of the present invention the step of adapting the identified constraint violation comprises generating a corrected process instance based on the process instance.

This has the advantage that a further process instance, namely a corrected process instance, is generated, which can be stored in a separate temporary memory, for instance a buffer.

In yet a further embodiment of the method according to an aspect of the present invention the step of generating the corrected process instance is performed iteratively and comprises deletion of duplicate corrected process instances.

This has the advantage that several corrected process instances are created as a function of different process instance adaptation techniques. Furthermore the user is provided with only unique process instances.

In yet a further embodiment of the method according to an aspect of the present invention the constraint is described by at least one of a group of constraint description techniques, the group comprising: an invariant, a restriction, a condition, a formal model, a semi-formal model, a file, a XML-format and an object constraint language.

This has the advantage that the constraint can be described according to a variety of well established representations.

In yet a further embodiment of the method according to an aspect of the present invention the constraint comprises at least one of a group of constraint features, the group comprising:
a control flow, an information flow, a cardinality, an entity, a phase, an activity, an artifact, a resource, a process, a process element and a constraint statement.

This has the advantage that a constraint can be described by means of well established constraint languages and process meta models.

Yet a further embodiment of the method according to an aspect of the present invention a machine is controlled as a function of the process instance.

This has the advantage that reliable and fault robust controlling of the machine is granted.

In yet a further embodiment of the method according to an aspect of the present invention the machine may comprise one of a group of entities, the group comprising:
a robot, a technical device, a production line, a plant, a computer system, a server, a client, a mobile device and a vehicle.

This has the advantage that the machine is not restricted to a specific type, but a variety of types is applicable in several scenarios.

In yet a further embodiment of the method according to an aspect of the present invention the process meta model is described by at least one of a group of modeling techniques, the group comprising:
an event process chain, a business process modeling notation, a unified modeling language and a process meta model specification language.

This has the advantage that the process meta-model as well as the process instance can be modeled by well established modeling techniques.

At least one embodiment is furthermore directed to an apparatus for adaptation of a process instance, the process instance violating at least one constraint. The apparatus comprises:
a first device for deriving a violation meta model from a process meta model being stored in a memory;
a second device for identifying a constraint violation in the process instance, the process instance being provided as a function of the stored process meta model; and
a third device for adapting the identified constraint violation based on the derived violation meta model.

Furthermore a computer program being adapted to perform the method on a computer as well as a data carrier which stores the computer program is provided.

### BRIEF DESCRIPTION OF THE DRAWINGS

In the following possible embodiments of the method and the apparatus for adapting a process instance are described with reference to the enclosed figures.

FIG. 1 shows a signal diagram as being used by the method for adapting a process instance according to an aspect of an embodiment of the present invention;

FIG. 2 shows a graphical user interface according to a method for adapting a process instance according to an aspect of an embodiment of the present invention;

FIG. 3 shows a flow diagram of a method for adapting a process instance according to an aspect of an embodiment of the present invention;

FIGS. 4A, 4B, 4C, 4D show an illustration of a method for adapting a process instance according to an aspect of an embodiment of the present invention;

FIG. 5 shows a block diagram of an apparatus for adaption of a process instance according to an aspect of an embodiment of the present invention; and

FIG. 6 shows a detailed block diagram of an apparatus for adaption of a process instance according to an aspect of an embodiment of the present invention.

In the following the same aspects are denoted with the reference signs if not indicated otherwise.

### DETAILED DESCRIPTION OF THE EXAMPLE EMBODIMENTS

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

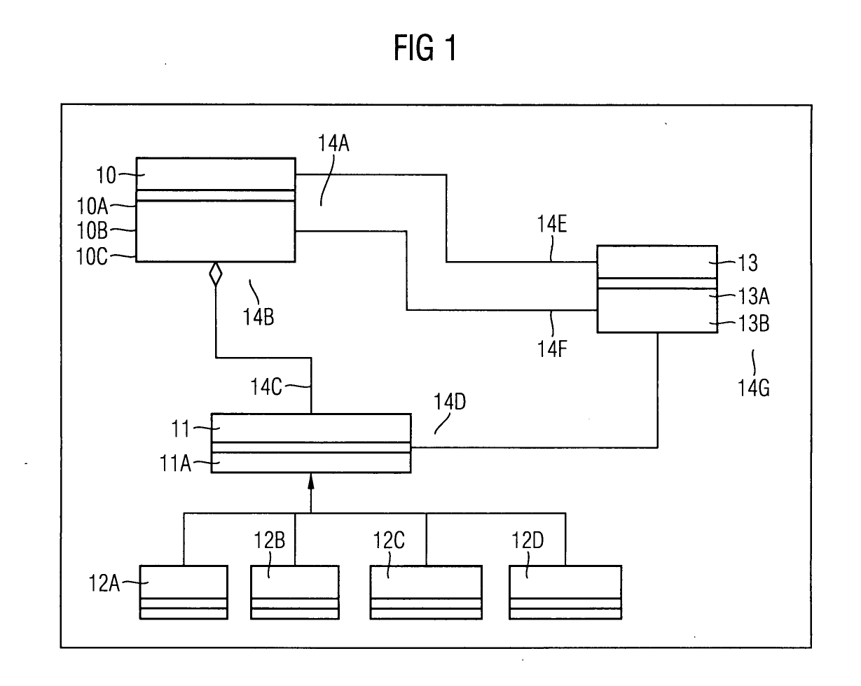

FIG. 1 shows a signal diagram for a method for adapting a process instance according to an aspect of an embodiment of the present invention. The arrangement of the signals being shown in FIG. 1 can also be interpreted as an architecture for components of a system for adapting processes and semi-automatic correction of incorrect processes, for instance processes violating constraints defined in a meta model.

A process may include entities, such as interfaces, activities, artifacts and resources. The types of entities shown in the present FIG. 1 are examples and can differ depending of the meta model of the process instance. A process and its entities can have constraints restricting their properties and relationships with other entities. Besides the classification in syntactic and semantic constraints, constraints can be classified in:
constraints restricting an entity, so called local constraints, for example an activity must have exactly one outgoing control flow, which can be described as follows:
Context activity inv.outgoing self→size( )=1
Constraints restricting a process, so called global constraints for instance a process must have exactly one start event, which can be described as follows:
Context Process inv.self.entities→collect(:each|each isKindOF:StartEvent)→collect(:each|each Phase=InvalidType)→size( )=1

For a more intuitive understanding the signals as being used herein are summarized in the following table:

| Reference signs | signal name |
|---|---|
| 10 | process( ) |
| 10A | +adapt process( ) |
| 10B | +check All( ) |
| 10C | +clone process( ) |
| 11 | entity |
| 11A | check constraints( ) |
| 12A | activity |
| 12B | artifact |
| 12C | resource |
| 12D | . . . |
| 13 | constraint |
| 13A | +check( ) |
| 13B | +correct( ) |
| 14A | +process |
| 14B | +process |
| 14C | +entities |
| 14D | +entity |
| 14E | +violation |
| 14F | +global constraints |
| 14G | +local constraints |

In the following one possible embodiment of the method for adapting a process instance according to an aspect of the present invention is demonstrated.

A process and its entities can be changed and/or adapted which includes instantiation by running adaptProcess( ). The resulting process might violate constraints. Constraints are checked using checkall( ) and when at least one constraint is violated, its function correct( ) may be called. The function correct( ) adjusts the process so that it complies with the violated constraint. The procedure of checking constraints and executing correct( ) of violated constraints is continued until all constraints are satisfied. The final process is handed back to the user for application or for further adaptation.

In the following a process correction approach is introduced according to an aspect of an embodiment of the present invention.

How a violation is to be corrected depends on the environment in which the entities causing the violation are settled in the process. It might be possible to correct a violation not only in one particular way but in a variety of ways depending on properties and relationships of entities in the process. The way a violated constraint is corrected also affects what violations follow and how they can be corrected. One might consider the following example: A process consists of the entities start-event, three activities in consecutive temporal order (A1, A2, A3) and an end-event.

A project manager of a project adapts the process by deleting the control flow connecting A1 and A2 and the control flow A2 to A3. One therefore inserts a split and a join of the type “AND”. The adaptation of the project manager on the process may result in an incorrect process.

The example process itself and its entities are restricted by a number of constraints.

The following constraints may be violated:
A1: inv self.outgoingCF→size( )=1
A2: inv self.incomingCF→size( )=1
A2: inf self.outgoingCF→size( )=1
A3: inf self.incomingCF→size( )=1
AndSplit: inv self.incomingCF→size( )=1
AndSplit: inv self.outgoingCF→size( )>=2
AndJoin: inv self.incomingCF→size( )>=2
AndJoin: inv self.outgoingCF→size( )=1

Each constraint may have a correct method specifying how to correct the process in order to satisfy the constraint. For example the function correct( ) associated with the constraint “Context Activity: inv self.outgoingCF→size( )=1” which is violated on activity A1 is defined as follows:
select instance of Entity (e) where
e.incomingCF.size( )<e.minNumberIncomingCF
create new ControlFlow(source=this.entity, target=e)

When executing correct( ) in the context of A1 there is more than one possibility to correct the process since there are several entities having too few incoming control-flows. A new control-flow to either A2, A3, AndJoin or AndSplit can be created.

The decision which entities are connected influences the further recovery procedure, i.e. has an impact on what resulting correct process is generated.

From this follows that in order to compute all possible processes, correct( ) may adjust a process and its entities in all possible ways resulting in an adapted process for every possibility. That means in the example described above, A1 is connected to A2, A3, AndJoin and AndSplit each in an individual process copy resulting in four process copies. Each resulting process is checked for violated constraints. As soon as a violation is found, its correct( ) copies the process for each possible correction and applies the corrections in the individual copies.

By applying this procedure a directed graph consisting of process copies may be created. The root of the graph corresponds to the initial incorrect process. The edges of the graph correspond to process corrections by correct methods of violated constraints.

In order to implement this procedure, the introduced architecture can be extended. Correct( ) creates for each possible process correction step a copy of the process, adapts it and eventually returns all copies. Returned copies are checked whether they violate constraints and if so, correct( ) of this constraint is called. This procedure is continued until all constraints are satisfied. Processes satisfying all constraints are saved and presented to the user which can decide which variation of the process to adopt after all possible solutions have been computed. The algorithm which can be used is shown in listing 1.

Listing 1: Recovery Algorithm:

| | |
|---|---|
| L1 | ArrayList<Process>recover(Process original){ |

| | |
|---|---|
| L2 | ArrayList<Process>solutions=new Array- |

List<Process>( );

| | |
|---|---|
| L3 | Stack<Process>lifo=new Stack<Process>( ); |
| L4 | Constraint con=original.checkAll( ); |
| L5 | if(con==null) |

| | |
|---|---|
| L6 | solutions.add(original); |

| | |
|---|---|
| L7 | else |

| | |
|---|---|
| L8 | lifo.push(original); |

| | |
|---|---|
| L9 | while(lifo.size( )!=0{ |
| L10 | original=lifo.pop( ); |

| | |
|---|---|
| L11 | Constraint vio=original.getViolation( ); |
| L12 | ArrayList<Process>processClones=vio.correct( ); |
| L13 | if(processClones!=null){ |

| | |
|---|---|
| L14 | for(Process p:processClones){ |

| | |
|---|---|
| L15 | Constraint con=p.checkAll( ); |
| L16 | if(con!=null) |

| | |
|---|---|
| L17 | lifo.push(p); |

| | |
|---|---|
| L18 | else |

| | |
|---|---|
| L19 | solutions.add(p); |

| | |
|---|---|
| L20 | } |

| | |
|---|---|
| L21 | } |

| | |
|---|---|
| L22 | } |
| L23 | return solutions; |

| | |
|---|---|
| L24 | } |

An instance of a process (original) is passed to the method. After creating a container for correct resulting processes (solutions) and a stack for storing the adapted (i.e. partly corrected) but still incorrect process copies (lifo), the method calls checkAll( ) of original returning the first violated constraint or NULL if no constraint is violated. In the latter case there is no need for further corrections and the original can be sent back to the caller as solution. In case there are violations, original is pushed onto the stack.

Until there are instances of process in stack lifo, the next instance is taken and correct( ) of its violation is called. The adapted process copies which are returned by correct( ) are checked. If there is at least one violation, the copy is pushed in the stack; otherwise the copy is added to the solution, which is eventually returned to the caller.

In the following particular design decisions are described according to an aspect of an embodiment of the present invention.

In order to make the approach more efficient a number of particular design decisions are made including creation of the graph consisting of processes, control of loops and duplicates in the graph, priority management of constraints and tracking of changes in processes.

Creation of process graph: For building the graph for correcting processes a “depth first algorithm” can be used. “Breadth first” may consume too much memory since many process clones have to be held in memory at the same time.

Loop and duplicate control: a Livelock in the graph and duplicated processes in solutions might occur. The former can happen when constraints loop. Constraints loop when a correct( ) adapts a process leading (not necessarily immediately) to a violation whose correct( ) causes a violation triggering the first correct( ) again. Duplicates in the resulting process solutions occur when two branches in the graph of processes join and the path leading from this spot is investigated (corrected) more than once.

A control mechanism avoiding such situations has to find out whether an identical process exists to a newly created and partly corrected process in the graph. This can be expensive since processes have to be compared with all processes in the graph.

However, a loop or joining branches can also be detected when a violation occurs more than once on the same object (i.e. entity in case it is a local constraint) on the path from the root to the current process in the graph. This approach is less expensive since only violations have to be compared. However, for it to work, correct( ) must solve a violation entirely (i.e. the constraint is not violated after the correction step any more) otherwise a loop would be detected that does not exist.

The latter approach is less expensive and correct methods can be defined to satisfy the restriction to correct a violation entirely. For controlling loops and duplicates in solutions we therefore check whether the same violation has already occurred in any ancestor of the process in the graph and if so, the path is no longer continued.

Priority management of constraints: Constraints can be very expensive to check. Consider the constraint that an artifact art has to be created by an activity act before it can be input of activities. For checking this constraint it has to be analyzed whether all activities having an input information-flow with art can be reached following the control-flows leading from act. All possible paths leading from act to end-events have to be investigated. It is desirable to check such expensive constraints as rarely as possible which can be accomplished by prioritizing constraints.

The algorithm described in Listing 1 may stop at the first violation in the process, corrects it and neglects possible further violations in the process. From this follows that violations occurred in more than one branch of the graph when there is more than one violation in a process since only one violation is corrected at a time. In most cases this is not an issue since most correct( ) can be run without human interaction and require only minor computational resources. However, some require user input, e.g. provide resource for executing activity, and users might be asked to provide the same information more than once. It is the case when there is a violation requiring user input in the process but this violation is not corrected first.

A plausible workaround is to cache user input. Another solution is to move constraints whose correct( ) requires user input as far up in the graph as possible, i.e. prioritize them, making them less likely to be executed more than once. However, this does not guarantee that a user is only asked once for particular information. For example: Two violations requiring user input have occurred at the same time in a process. Only one of them can be corrected first. For the second the user might have to insert the information more than once since it will exist in all resulting process copies of the correction of the first violation.

However, since this occurs rarely, one can prioritize constraints where
highest priority is given to constraints requiring user input for their correction.
modest priority is given to constraints requiring no user input and with low or modest expensiveness for checking.
lowest priority is given to constraints requiring no user input for correction, but being expensive to check.

This enables checking expensive constraints as rarely as possible and minimizes multiple insertion of user input.

Change Tracking: There might be more than one resulting correct process solution. Users have to investigate corrections made by the system and decide which correct process they want to adopt. Due to the size and complexity of most software processes it is cumbersome for users to track corrections made by the system, i.e. find differences of the resulting process solutions. Therefore we track IDs of deleted, changed or created entities for each resulting process allowing users to locate changes in the process made by the system.

For a more intuitive understanding listing 1 is explained in more detail. In first line L1 an input parameter is specified, namely “original” of type process. In a second line L2 a new array is created. In line L3 a new stack is created of type “process”. In the forth line L4 the process instance, which served as input parameter is checked for constraint violations. In line L5 and L6 the process instance to be a examined, namely “original” is provided as a solution in case no constraint is being violated. As indicated in lines L7 and L8 the process violating constraints is being pushed on the stack.

In the further lines all process instances comprising a constraint violation are being handled and therefore are popped of the stack. In line L11 the constraint, which is being violated by the process instance is detected by the method getViolation( ). In line L12, the constraint's correct( ) is called which returns adapted processes which are saved to a newly created array processClones. The number of returned processes depends on the number of possible corrections for the violated constraint. Each possible correction is executed on an individual copy of the process. If adapted processes are returned by correct( ) the processes are taken one by one from the array (Line L14). Each adapted process is checked for violated constraints (line L15). If violations are present, the first violation found is returned and saved in con. In line L16 it is tested whether con contains a constraint violation. If it is the case, the process is still incorrect and is pushed in stack lifo (line L17). Otherwise it is corrected and saved to solutions (line L19). If there are still processes in stack lifo, execution continues in line L10. Otherwise, the solutions, which are the corrected process instances, are returned in line L23.

The afore mentioned steps can be performed iteratively and/or in different order. The person skilled in the art appreciates that further variations of the algorithm may be applied and furthermore that other algorithms can be used as a recovery algorithm to be applied by the method for adapting a process instance according to an aspect of an embodiment of the present invention.

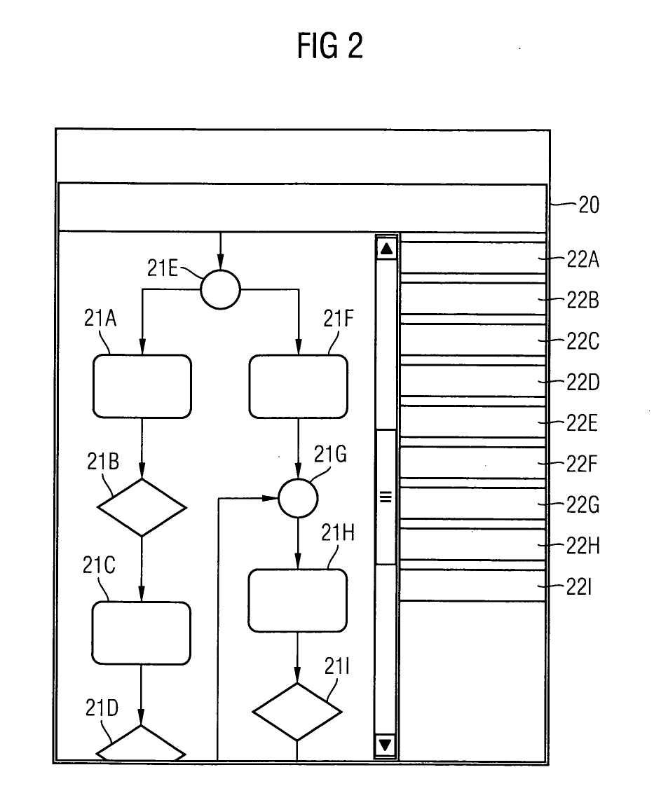

FIG. 2 shows a user interface 20 for controlling a machine especially by an apparatus for adaption of a process instance according to an aspect of an embodiment of the present invention. In the present embodiment interface is provided which shows a control flow of a machine, the control flow being comprised of several elements of a process instance. The process elements 21A, 21B, 21C, 21D, 21E, 21F, 21G, 21I may for instance hold the following semantics:

| reference signs | signal name |
|---|---|
| 21A | concept update |
| 21B | 110.x |
| 21C | discipline development |
| 21D | 1120.x |
| 21E | AND split |
| 21F | realize |
| 21G | AND join |
| 21H | Declare milestone 300 |
| 21I | 300 |

The user interface 20 furthermore provides a number of operations, which can be performed on the process instance. The operations can be summarized as follows:

| reference signs | operations |
|---|---|
| 22A | iterate Phase |
| 22B | delete Phase |
| 22C | insert activity |
| 22D | delete activity |
| 22E | insert milestone |
| 22F | delete milestone |
| 22G | insert path |
| 22H | add artifact |
| 22I | add participant |

It is possible to input a process instance, the process violating at least one constraint into the apparatus for adaption of a process instance by the user interface 20. The apparatus for adaption of a process instance is designed to output an adapted identified constraint violation, which means to output a corrected process instance. Furthermore an adaption of the process instance is possible.

While in the present FIG. 2 the user interface 20 is a graphical user interface, the person skilled in the art appreciates further user interfaces. It is possible that no graphical user interface is designed for the apparatus for adaption of a process instance, but that the output, which means the corrected process instance, is directly input to a machine to be controlled.

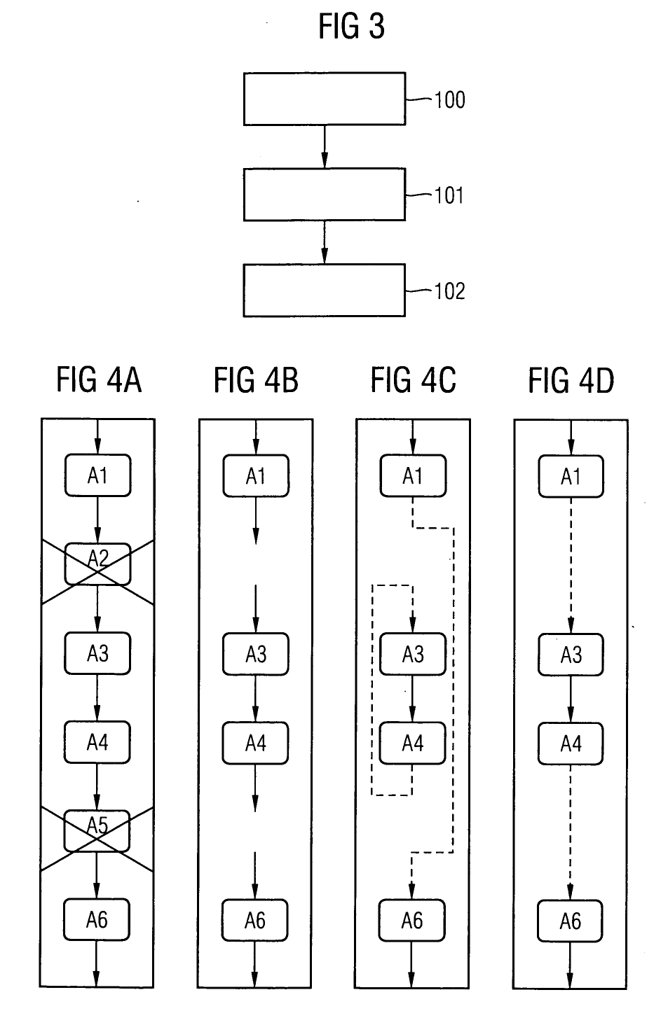

FIG. 3 shows an activity diagram of method for adapting a process instance according to an aspect of an embodiment of the present invention. The method for adapting a process instance comprises the following steps:
deriving 100 a violation meta model from a stored process meta model;
identifying 101 a constraint violation in the process instance, the process instance being provided as a function of the stored process meta model; and
adapting 102 the identified constraint violation based on the derived violation meta model.

The afore mentioned steps can be performed iteratively and/or in a different order.

FIG. 4 shows an illustration of the method for adapting a process instance according to an aspect of an embodiment of the present invention. In the present embodiment the process instance comprises a sequence of six activities A1, A2, A3, A4, A5 and A6, which are consecutively ordered. In FIG. 4A, two activities are deleted, namely activity A2 and activity A5. A process instance results as being shown in FIG. 4B which violates a process meta model. In the present process meta model, which applied to the process instances being shown in the present FIGS. 4A, 4B, 4C and 4D a control flow must relate two activities. In the present FIG. 4B these restrictions are violated. The already introduced correct( ) function of violated constraints on control flows which do not have a valid target may search for control flows with a missing source and merges them. The violated constraint of control flows with a missing source acts accordingly, leading to process instances as being shown in FIG. 4C and FIG. 4D. Syntactically process instances as being shown in FIG. 4C might be correct, however semantically they are not useful. With sequential execution of deletion of A2 and A5, each followed by process correction, the solution as being shown in FIG. 4C would not have appeared.

From this follows that certain constraints, for instance on control flows, have to be checked and corrected after execution of each operator of a batch. A batch may be a sequence of function and may further be referred to as a high level instantiation.

Batch executions of operators can lead to obvious incorrect interactions between possible correction choices. This is especially inefficient and cumbersome if the correction of the violation requires user input or is expensive regarding computational resources.

For example, assume an activity A is deleted having an output information flow with a work product W, for instance A creates W and there is another activity B using W as input information flow, causing a violation because W is input of an activity but never created. If the activities having W as input information flow are deleted in later stage of the batch, the correction will be unnecessary.

From this follows that particular constraints, such as on information flows, have to be executed not before all operators of the batch are executed.

These issues can be resolved by prioritizing constraints at two levels. Constraints with priority may be checked, and if necessary, corrected after the execution of each operator, thus limiting the number of possible resulting processes. Constraints with priority may be executed after all operators of the batch have been executed thus making the process adaption more efficient by awarding unneeded constraint checking and correction.

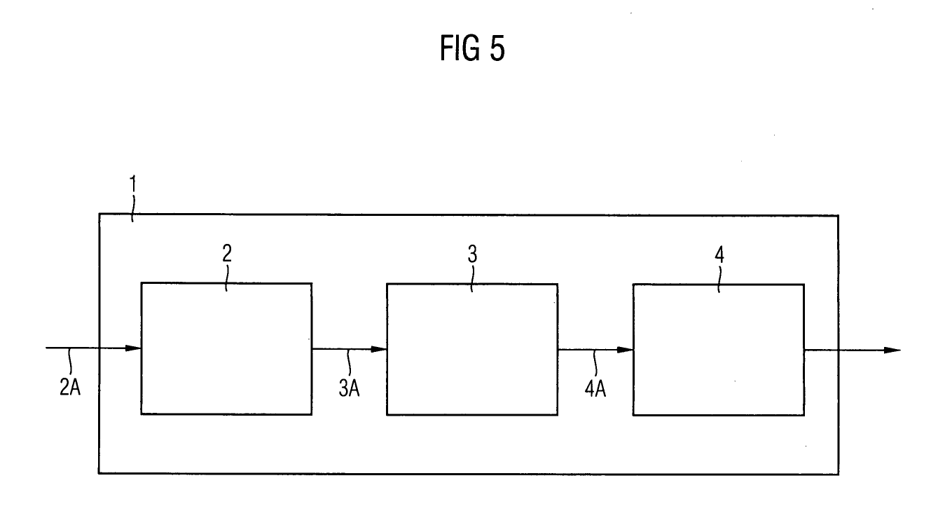

FIG. 5 shows a block diagram of an apparatus 1 for adaption of a process instance 2A, the process instance 2A violating at least one constraint, the operators 1 comprising:
a first device 2 for deriving a violation meta model 3A from a process meta model being stored in a memory;
a second device 3 for identifying a constraint violation 4A in the process instance 2A, the process instance 2A being provided as a function of the stored process meta model; and
a third device 4 for adapting the identified constraint violation 4A based on the derived violation meta model 3A.

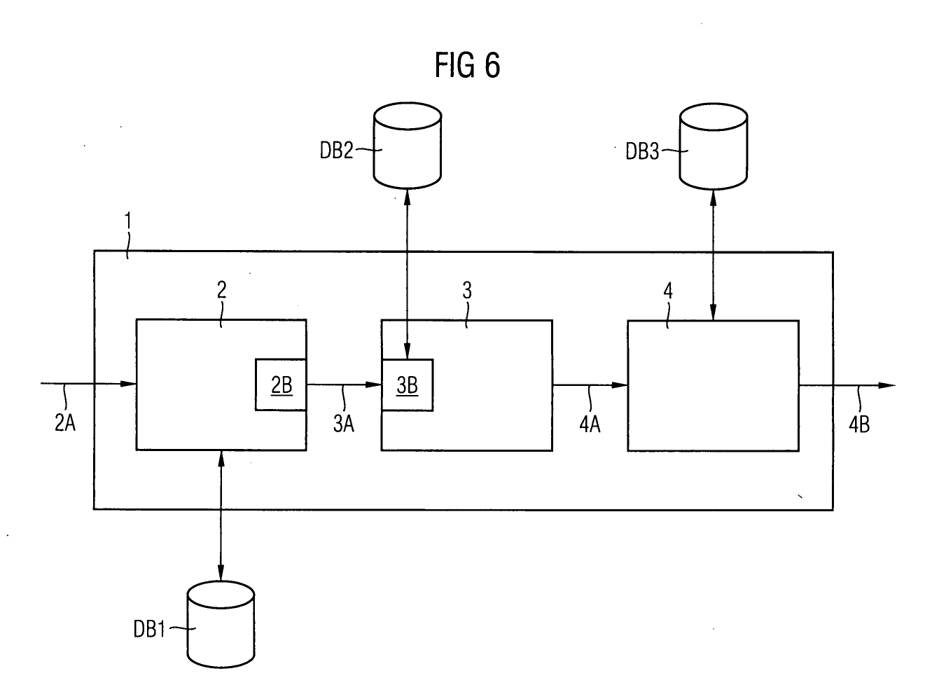

FIG. 6 shows a detailed block diagram of an apparatus 1 for adaption of a process instance 2A, which differs from the apparatus 1 as being shown in the FIG. 5 as follows:

In the present embodiment as being shown in FIG. 6 a violation meta model 3A is being comprised in a storage device DB1. The storage device DB1 may be contacted for providing the violation meta model 3A, for instance by a meta base lookup. For deriving the violation meta model 3A the first device 2 for deriving a violation meta model may furthermore comprise a derivation unit 2B, which is designed to generate a violation meta model 3A. Once the violation meta model 3A is created and/or derived it is provided to the second device 3 for identifying a constraint violation 4A. The second device 3 identifying a constraint violation 4A may furthermore comprise a data storage DB2, which provides the stored process meta model. For obtaining a process instance 2A the second device 3 may comprise a process meta model instantiation unit 3B. The process meta model instantiation unit 3B may be designed to created the process instance 2A or to obtain the process instance 2A from at least one of the data storages DB1 and/or DB2. Therefore the process meta model instantiation unit 3B may also be comprised in the first device 2 for deriving a violation meta model 3A.

After a constraint violation 4A is detected the third device 4 can identify a constraint violation remedy, which means a process instance adaption technique, from a storage device DB3. This may comprise selecting one process instance adaptation technique, which is designed to adapt the process instance 2A inefficient, that the process instance 2A is conform to the stored process meta model. Hence the third device 4 for adapting the identified constraint violation 4A is designed to create a corrected process instance 4B, which is being output.

At least one of the introduced storage devices, especially the storage device DB1, DB2 and DB3, may comprise any type of storage, for instance a hard drive a flash disk, a USB stick, a floppy disk, a disk, a CD, a DVD, a Blu Ray Disk a band/or a removably storage medium. Furthermore the storage devices DB1, DB2 and/or DB3 may be accessed over a network, the network comprising further network typical components, such as a switch, a router, a client, a server and/or other typical network devices being required for operating a network. The network can be designed to send signals and/or data over a cable or over a wireless interface.

The patent claims filed with the application are formulation proposals without prejudice for obtaining more extensive patent protection. The applicant reserves the right to claim even further combinations of features previously disclosed only in the description and/or drawings.

The example embodiment or each example embodiment should not be understood as a restriction of the invention. Rather, numerous variations and modifications are possible in the context of the present disclosure, in particular those variants and combinations which can be inferred by the person skilled in the art with regard to achieving the object for example by combination or modification of individual features or elements or method steps that are described in connection with the general or specific part of the description and are contained in the claims and/or the drawings, and, by way of combinable features, lead to a new subject matter or to new method steps or sequences of method steps, including insofar as they concern production, testing and operating methods.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program, computer readable medium and computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a computer readable medium and is adapted to perform any one of the aforementioned methods when run on a computer device (a device including a processor). Thus, the storage medium or computer readable medium, is adapted to store information and is adapted to interact with a data processing facility or computer device to execute the program of any of the above mentioned embodiments and/or to perform the method of any of the above mentioned embodiments.

The computer readable medium or storage medium may be a built-in medium installed inside a computer device main body or a removable medium arranged so that it can be separated from the computer device main body. Examples of the built-in medium include, but are not limited to, rewriteable non-volatile memories, such as ROMs and flash memories, and hard disks. Examples of the removable medium include, but are not limited to, optical storage media such as CD-ROMs and DVDs; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for adapting a process instance, the process instance violating at least one constraint, the method comprising:
deriving a violation meta model of a stored process meta model;
identifying a constraint violation in the process instance, the process instance being provided as a function of the stored process meta model; and
adapting the identified constraint violation based on the derived violation meta model.

2. The method according to claim 1, wherein the derived violation meta model comprises at least one process instance adaption technique.

3. The method according to claim 1, wherein the identifying of the constraint violation is performed as a function of the derived violation meta model.

4. The method according to claim 1, wherein the derived violation meta model describes at least one constraint violation.

5. The method according to claim 1, wherein at least one process instance adaption technique is assigned to each constraint violation.

6. The method according to claim 1, wherein the adapting of the identified constraint violation comprises generating a corrected process instance based on the process instance.

7. The method according to claim 6, wherein the generating of the corrected process instance is performed iteratively and comprises deletion of duplicate corrected process instances.

8. The method according to claim 1, wherein the constraint is described by at least one of a group of constraint description techniques, the group comprising: an invariant, a restriction, a condition, a formal model, a semi-formal model, a file, an xml format and an object constraint language.

9. The method according to claim 1, wherein the constraint comprises at least one of a group of constraint features, the group comprising: a control flow, an information flow, a cardinality, an entity, a phase, an activity, an artifact, a resource, a process element and a constraint statement.

10. The method according to claim 1, wherein a machine is controlled as a function of the process instance.

11. The method according to claim 10, wherein the machine comprises at least one of a group of entities, the group comprising: a robot, a technical device, a production line, a plant, a computer system, a server, a client, a mobile device and a vehicle.

12. The method according to claim 1, wherein the process meta model is described by at least one of a group of modeling techniques, the group comprising: an event process chain, a business process modeling notation, a unified modeling language and a process meta model specification language.

13. An apparatus for adaption of a process instance, the process instance violating at least one constraint, said apparatus comprising:
a first device to derive a violation meta model from a process meta model stored in a memory;
a second device to identify a constraint violation in the process instance, the process instance being provided as a function of the stored process meta model; and
a third device to adapt the identified constraint violation based on the derived violation meta model.

14. A computer program being adapted to perform the method of claim 1 when executed on a computer.

15. A data carrier comprising a stored computer program according to claim 14.

16. A computer readable medium including program segments for, when executed on a computer device, causing the computer device to implement the method of claim 1.

17. A method for adapting a process instance, the process instance violating at least one constraint, the method comprising:
providing a stored process meta model;
deriving a violation meta model of a stored process meta model;
identifying a constraint violation in the process instance, the process instance being provided as a function of the stored process meta model; and
adapting the identified constraint violation based on the derived violation meta model.

18. The method according to claim 17, wherein a machine is controlled as a function of the process instance.

19. The method according to claim 18, wherein the machine comprises at least one of a group of entities, the group comprising: a robot, a technical device, a production line, a plant, a computer system, a server, a client, a mobile device and a vehicle.

20. A computer readable medium including program segments for, when executed on a computer device, causing the computer device to implement the method of claim 17.
